(19) United States
(12) Patent Application Publication
(10) Pub. No.: US 2007/0137735 A1
(43) Pub. Date: Jun. 21, 2007

(54) Method for treating ferrous alloy parts by sulphurization

(75) Inventors: Philippe Maurin-Perrier, Saint Marcellin En Forez (FR); Christophe Heau, Saint Etienne (FR)

Correspondence Address: HESLIN ROTHENBERG FARLEY & MESITI PC, 5 COLUMBIA CIRCLE, ALBANY, NY, 12203, US

(73) Assignee: H.E.F., Andrezieux Boutheon (FR)

(21) Appl. No.: 10/575,747

(22) PCT Filed: Oct. 6, 2004
(86) PCT No.: PCT/FR04/50487

§ 371 Date: Apr. 10, 2006

(30) Foreign Application Priority Data
Oct. 14, 2003 (FR) 0312200

(51) Int. Cl. B05D 1/18; C23C 22/48

(52) U.S. Cl. 148/270; 427/430.1

(57) ABSTRACT

Ferrous alloy parts are immersed in a bath of an aqueous solution, without passage of an electric current. The solution comprises caustic soda at concentrations of between 400 and about 1000 f/l, sodium thiosulphate at concentrations of between 30 and about 300 g/l, and sodium sulphide at concentrations of between 60 and about 120 g/l. The solution is heated to a temperature between about 100° C. and 140° C. for a period of between 5 and about 30 minutes.

The invention relates to a method for treating metal surfaces and, more generally, surfaces of ferrous alloy parts, in order to improve their resistance to jamming.

Such treatments are perfectly familiar to a person skilled in the art and widely used in designing mechanical elements, for example when parts have to rub against one another under severe load and pressure conditions. These treatments can also apply, or be applied, both in cases of lubrication (with oil, grease, etc.) and in cases of the absence of such lubrication.

Various methods have been proposed to form, on the surface of the ferrous alloy parts, compounds suitable for improving interactions with the environment.

The various known treatment methods include superficial oxidation methods which are suitable for improving the corrosion resistance. Also known are tool phosphatization methods which, by creating a superficial layer of iron phosphate, are used to improve the effects of lubrication in substantial proportions.

Finally, sulphurization treatment methods are known.

The invention relates more particularly to the latter type of treatment.

The sulphurization of steels and the effects of a superficial layer of iron sulphide on lubrication are perfectly familiar to a person skilled in the art and, for example, appear from the teaching of Patents FR 1 406 530 and FR 2 823 227.

According to the teaching of Patent FR 1 406 530, the treated metal parts are immersed in a bath of ionized molten salt. This electrolytic sulphurization with molten salts can pose a threat to the environment.

According to the teaching of Patent FR 2 823 227, an iron sulphide coating having an appropriate thickness and Fe/S ratio is deposited on the part to be treated, the coating being selected from those of which the surface has a fractal dimension of at least 2.6. Here also, the method employs electrolytic sulphurization, which can create technical constraints limiting its productivity. It may also be observed that the salts used are expensive.

Another solution appears from the teaching of U.S. Pat. No. 6,139,973 which relates to a method used to deposit iron sulphide by cathodic electrolysis of an aqueous solution. Among the drawbacks, apart from the limitations inherent in the electrolytic method pertaining to the shape of the parts to be treated, it appears that the Fe/S layer is not obtained by chemical reaction, but deposited on the steel surface, and this raises real problems of adhesion.

The problem that the invention proposes to solve is to reduce the toxicity, on the one hand, and to avoid the use of electrolysis, on the other, so that the energy needed is limited to maintaining the aqueous solution at a predetermined temperature.

It is also observed that the absence of current flow makes it possible to control the composition, thickness and continuity of the superficial layers with great accuracy and high reproducibility, and also makes it possible to treat parts of complex shape, including those with cavities (bores, blind holes, gears, etc.).

To solve such a problem, a method has been designed and developed for treating ferrous alloy parts by sulphurization, whereby the parts are immersed in a bath of an aqueous solution, without the passage of an electric current, heated to a temperature between about 100° C. and 140° C. for a period of between 5 and about 30 minutes. The bath of aqueous solution has concentrations of caustic soda, sodium thiosulphate and sodium sulphide.

Caustic soda is corrosive to ferrous alloy parts and allows the liberation of Fe²⁺ and Fe³⁺ ions necessary for the precipitation of a layer of iron sulphide on the parts. The sulphur component of the thiosulphate also allows the precipitation of this layer of iron sulphide. Finally, iron sulphide is also an important agent in the sulphurization method.

Advantageously, the sulphurizing power of the bath requires the presence of caustic soda in concentrations between 400 and 1000 g/l, of sodium thiosulphate in concentrations between 30 and 300 g/l, and of sodium sulphide in concentrations between 60 and 120 g/l.

Advantageously, the bath working temperature is between about 120° C. and 140° C. For the sake of simplification, it is possible to work at the boiling point, which depends on the composition of the aqueous solution.

The resistance to jamming resulting from the treatment method according to the invention is evaluated by the test on the Faville Levally machine according to standard ASTM-D-2170.

In a manner perfectly known to a person skilled in the art, this test consists in treating a case-hardened, quenched and ground 16NC6 steel cylindrical test specimen 6.35 mm in diameter and 50 mm in height. The specimen is clamped between two jaws cut in a right-angled V to which a load is applied increasing linearly as a function of time. The test is stopped when jamming or flow of the specimen occurs. This test is characterized by a quantity called the Faville grade, which is the integral of the load applied with respect to time, this grade being expressed in daN·s. In this respect, it has appeared that, when the specimen is treated by the method according to the invention, the Faville grade must be higher than 12 000 daN·s and the specimen must have flowed and not jammed.

Reference is made below to the non-limiting examples provided for information, which show the results obtained with the features of the method according to the invention, in comparison with treatments according to the prior art.

### EXAMPLE 1

In this example, a comparison is made between the Faville grade of test specimens of case-hardened, quenched 16NC6 steel, in the case of an untreated specimen (1), a phosphatized specimen (2), an oxidized specimen (3), a specimen according to the method of the invention (4). The results are given in the table below:

| | 1 | 2 | 3 | 4 |
|---|---|---|---|---|
| | Untreated | Phosphatized | Oxidized | Sulphurized |
| | specimen | specimen | specimen | specimen |
| Faville | 5000 | 5500 | 5300 | 15 000 |
| grade | | | | |
| daN · s | | | | |
| End of | Jamming | Jamming | Jamming | Flow |
| test | | | | |

The specimen treated according to the invention is quenched in an aqueous solution containing, on the preparation of the bath, 775 g/l of caustic soda, 200 g/l of sodium thiosulphate and 90 g/l of sodium sulphide. The treatment is carried out at 130° C. for 15 minutes.

It appears from this test that solutions 1, 2 and 3 do not impart any anti-jamming property to the part, whereas solution 4, according to the invention, is characterized by a high anti-jamming effect, considering that the Faville grade is multiplied by 3.

### EXAMPLE 2

In this example, a comparison is made between the Faville test specimens of case-hardened, quenched 16NC6 steel, sulphurized by the method according to the invention (1) and by the electrolytic method, as it appears from the teaching of Patent FR 2 823 227. The results are given in the table below:

| | 1 | 2 |
|---|---|---|
| | Specimen | Specimen |
| | sulphurized | sulphurized |
| | according to the | according to FR 2 |
| | invention | 823 227 |
| Faville grade | 15 000 | 11 000 |
| daN · s | | |
| End of test | Flow | Flow |

The specimen according to the invention is treated in an aqueous solution containing, on preparation of the bath, 775 g/l of caustic soda, 200 g/l of sodium thiosulphate and 90 g/l of sodium sulphide.

The treatment was carried out at 130° C. for 15 minutes.

It appears from these tests that solutions 1 and 2 have anti-jamming properties and that the specimen sulphurized according to the method of the invention (1) presents a 36% improvement in anti-jamming behaviour.

### EXAMPLE 3

In this example, all the specimens are treated in aqueous solution by varying the temperature and initial concentrations of caustic soda (NaOH), sodium thiosulphate (Na₂S₂O₃), sodium sulphide (Na₂S).

The results are given in the table below:

| | Solution | | | | | |
|---|---|---|---|---|---|---|
| | 1 | 2 | 3 | 4 | 5 | 6 |
| Temperature | 130 | 130 | 130 | 80 | 130 | 130 |
| (g/l) | | | | | | |
| NaOH (g/l) | 775 | 775 | 1000 | 775 | 550 | 275 |
| Na₂S₂O₃ | 200 | 0 | 200 | 200 | 200 | 200 |
| (g/l) | | | | | | |
| Na₂S (g/l) | 90 | 90 | 0 | 90 | 120 | 90 |
| Faville | 15 000 | 5300 | 8300 | 6000 | 14 000 | 8500 |
| grade daN · s | | | | | | |
| End of test | Flow | Jam- | Jamming | Jam- | Flow | Jam- |
| | | ming | | ming | | ming |

It appears from this table that:
Solution 1 conforms to the desired features given the preparation conditions and the grade of the Faville test.
Solutions 2 and 3 do not conform, considering their initial concentrations of sodium thiosulphate and sodium sulphide. These two examples illustrate the synergistic effect of thiosulphates and sulphides for the treatment of steels.
Solution 4, which is similar to solution 1 as regards the composition of the aqueous solution, does not conform because of the treatment temperature, which is too low for reactions on the specimen to take place effectively and to impart a resistance to jamming.
Solution 5 yields a satisfactory result in terms of anti-jamming properties, despite a different bath composition to that of solution 1.
Solution 6 does not produce a satisfactory anti-jamming response because the caustic soda concentration is too low.

According to the features of the invention, it is observed that the parts, treated according to the claimed method, have oxygen in the different layers.

The advantages clearly appear from the description, and the following features are emphasized and repeated:
respect for the environment;
very accurate and highly reproducible control of the composition, thickness and continuity of the superficial layers;
the absence of current flow making it possible, in particular, to treat parts of complex shape, including those having cavities.

1. Method for treating ferrous alloy parts by sulphurization, wherein the parts are immersed in a bath of an aqueous solution, without the passage of an electric current, comprising caustic soda at concentrations of between 400 and about 1000 g/l, sodium thiosulphate at concentrations of between 30 and about 300 g/l, and sodium sulphide at concentrations of between 60 and about 120 g/l, said solution being heated to a temperature between about 100° C. and 140° C. for a period of between 5 and about 30 minutes.

2. Method according to claim 1, wherein the temperature is between about 120° C. and 140° C.

3. Method according to claim 1, wherein the period is about 15 minutes.

4. Parts treated according to the method of claim 1.

5. The method according to claim 2, wherein the temperature is about 130° C.
